(19) United States
(12) Patent Application Publication
(10) Pub. No.: US 2001/0030403 A1
(43) Pub. Date: Oct. 18, 2001

(54) Dog grooming cart

(76) Inventors: Dan E. Johnson, Dublin, OH (US); Laura K. Edwards, Dublin, OH (US)

Correspondence Address: Attn: Intellectual Property Department, PORTER, WRIGHT, MORRIS & ARTHUR, LLP, 41 South High Street, Columbus, OH, 43215, US

(21) Appl. No.: 09/737,445

(22) Filed: Dec. 13, 2000

Related U.S. Application Data
(60) Provisional application No. 60/170,936, filed on Dec. 15, 1999.

(51) Int. Cl. B62B 1/18

(52) U.S. Cl. 280/47.26

(57) ABSTRACT

A grooming cart is provided that comprises a housing having an open top portion and an open front portion, at least one pair of wheels pivotally mounted to the housing, a top, and a front. The housing includes a top tray and at least one storage compartment below the top tray. The top is pivotally mounted to the housing and is movable between a closed position where the top portion of the housing is covered and an open position where the top portion of the housing is open. The front is pivotally mounted to the housing and is movable between a closed position where the front portion of the housing is covered, an open position where the front portion of the housing is open, and a storage position where the front portion of the housing is open and the front is positioned substantially within the housing.

### RELATED APPLICATION

This application claims priority benefit of U.S. Provisional Patent Application No. 60/170,936 filed on Dec. 15, 1999.

### FIELD OF THE INVENTION

The present invention relates generally to a portable storage device and, more specifically, to a device for storing and transporting dog grooming items and making such items easily accessible while grooming a dog at dog shows and the like.

### BACKGROUND OF THE INVENTION

Grooming cases are used to store and transport various dog grooming products, such as clippers, brushes, shampoos, and the like, as well as other items used during dog shows, such as leads. Conventional dog grooming cases are heavy and are not easily transportable, particularly when the cases must be moved over uneven terrain or loaded into a vehicle. All of such cases are made of metal or wood, typically with square comers that can injure a user or make the case more difficult to fit through narrow spaces. These cases do not provide easy access to materials and items contained within the case, and do not restrain the items within the case to ensure there is no shifting or shuffling of the items during transportation that might cause damage or disorder to these items. Also, these cases do not provide separate storage for items such as shampoos, conditioners, and other liquid products from other items, such as expensive clippers, that may be damaged if the two items were to come into contact.

A need exists for a dog grooming cart that is compact and easily transportable, that protects the contents of the cart, that properly restrains the contents of the cart, that provides easy access to the contents of the cart while a dog is being groomed and readied for showing, and that is convenient to use.

### SUMMARY OF THE INVENTION

The present invention provides a grooming cart which overcomes at least some of the above-noted problems of the related art. According to the present invention, a storage cart is provided that comprises a housing having an open top portion and an open front portion, at least one pair of wheels pivotally mounted to the housing, a top, and a front. The housing includes a top tray and at least one storage compartment below the top tray. The top is pivotally mounted to the housing and is movable between a closed position where the top portion of the housing is covered and an open position where the top portion of the housing is open. The front is pivotally mounted to the housing and is movable between a closed position where the front portion of the housing is covered, an open position where the front portion of the housing is open, and a storage position where the front portion of the housing is open and the front is positioned substantially within the housing.

In one preferred embodiment of the present invention, the front may be pivotally mounted to the housing on mounting pins and may include channels that slidably receive the mounting pins such that the front is slidable to its storage position.

In another preferred embodiment of the present invention, the top defines exterior and interior surfaces and the cart further comprises two wire forms pivotally mounted on the interior surface of the top, each wire form having a kickstand portion. Each wire form is movable between a closed position where the wire forms are substantially parallel with a plane formed by the top and an open position where the wire forms are about perpendicular with the plane formed by the top. Two wire form holders are connected to the housing, and each wire form holder is adapted to accept the kickstand portion of one of the wire forms such that the top is maintained in its open position when the kickstand portions of the wire forms are positioned in the wire form holders.

The cart may further comprise at least one pair of hooks mounted oppositely to one another on an interior surface of the top. The cart may also include an integral handle on the top. Corners formed by the housing are preferably rounded.

These and further features and advantages of the invention will become apparent from the following detailed description.

### BRIEF DESCRIPTION OF THE DRAWINGS

FIG. 1 is a perspective view of a preferred embodiment of a dog grooming cart according to the present invention shown with the front and the top in an open position.

FIG. 2 is an enlarged perspective view of a portion of the dog grooming cart of FIG. 1 shown with the top in an open position and the wire forms in a closed position.

FIG. 3 is an enlarged perspective view of a portion of the dog grooming cart of FIG. 1 shown with the top in an open position and the wire forms in an open position.

FIG. 4 is a perspective view of the dog grooming cart of FIG. 1 shown from the back of the dog grooming cart with the top in a closed position and with the handle adjusted to its lowest position.

FIG. 5 is a perspective view of the dog grooming cart of FIG. 4 shown with the handle adjusted to its highest position.

FIG. 6 is a perspective view of the dog grooming cart of FIG. 4 shown from the bottom of the dog grooming cart with the front and the top in a closed position.

FIG. 7 is a perspective view of the dog grooming cart of FIG. 1 shown with the front and the top in a closed position.

It should be understood that the appended drawings are not necessarily to scale, presenting a somewhat simplified representation of various preferred features illustrative of the basic principles of the invention.

### DETAILED DESCRIPTION OF THE PREFERRED EMBODIMENT

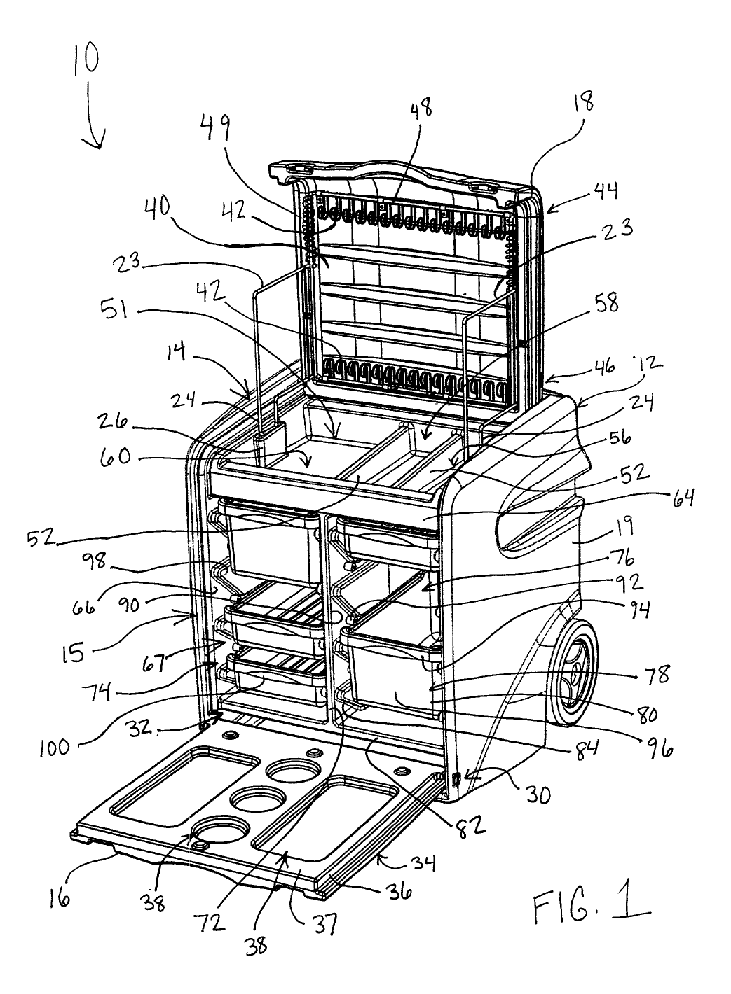

FIGS. 1-7 illustrate a dog grooming cart 10 according to a preferred embodiment of the present invention. While the illustrated embodiments of the dog grooming cart 10 of the present invention are particularly adapted for use with dog grooming equipment for dog shows, it is noted that principles of the invention are applicable to carts for use in other storage capacities such as storing grooming material for other animals. Other embodiments suitable for other applications will be readily apparent to those skilled in the art given the benefit of this disclosure.

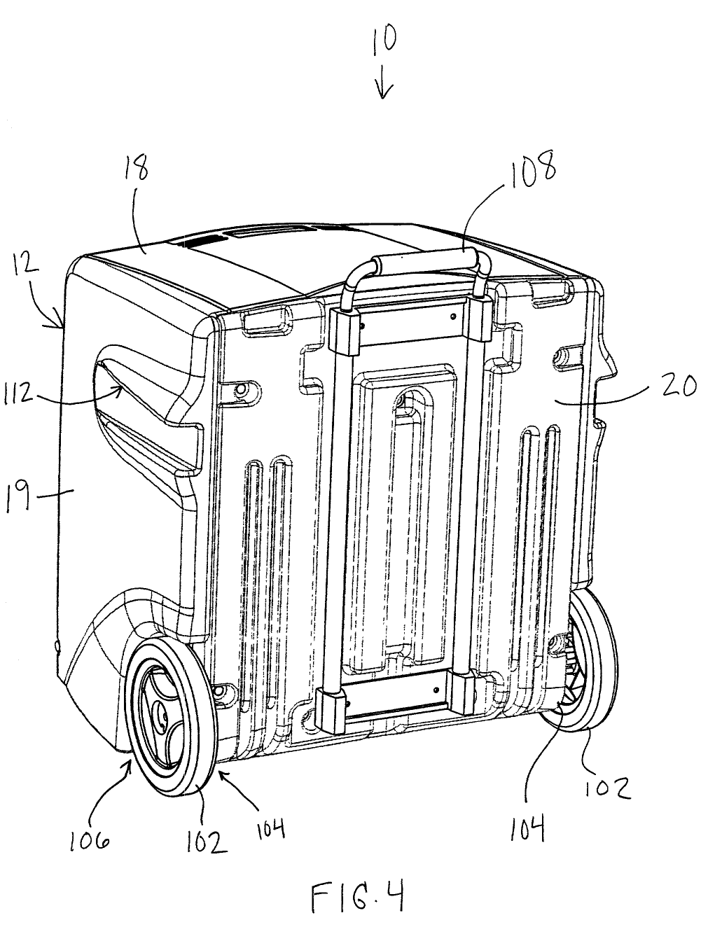

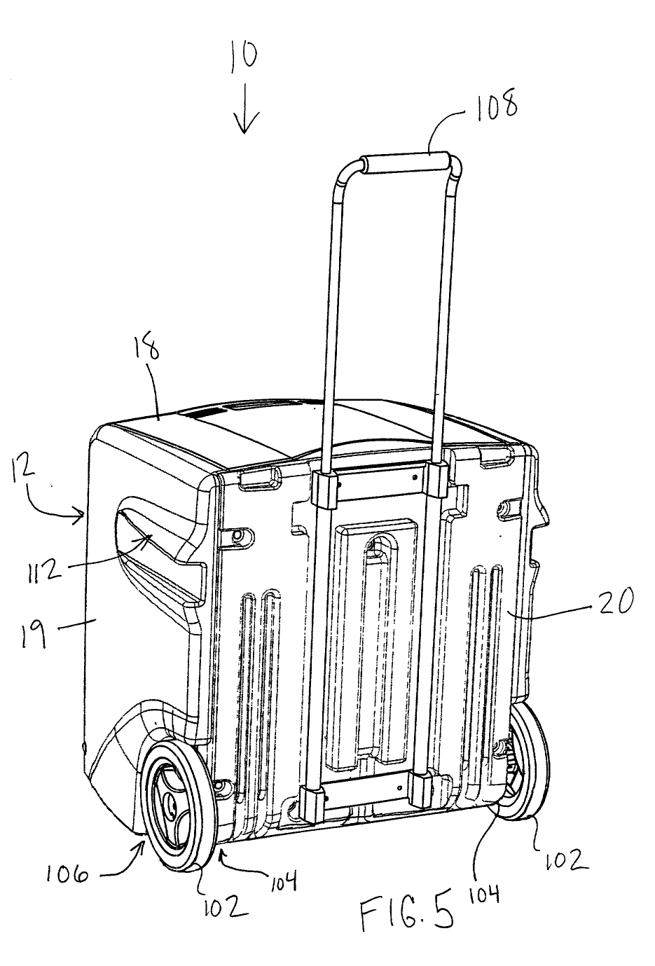

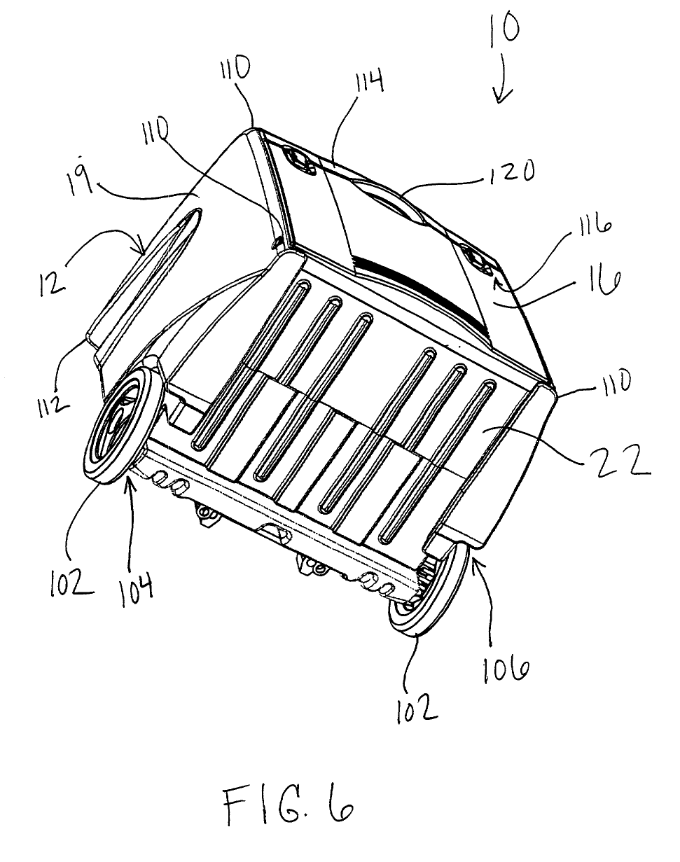

As illustrated in the drawings, the preferred embodiment of the dog grooming cart 10 comprises a housing 12 having an open top portion 14 and an open front portion 15. The dog grooming cart 10 also comprises a front 16 and a top 18. The housing 12 preferably comprises two sides 19, a back 20 (FIGS. 4 and 5), and a bottom 22 (FIG. 6).

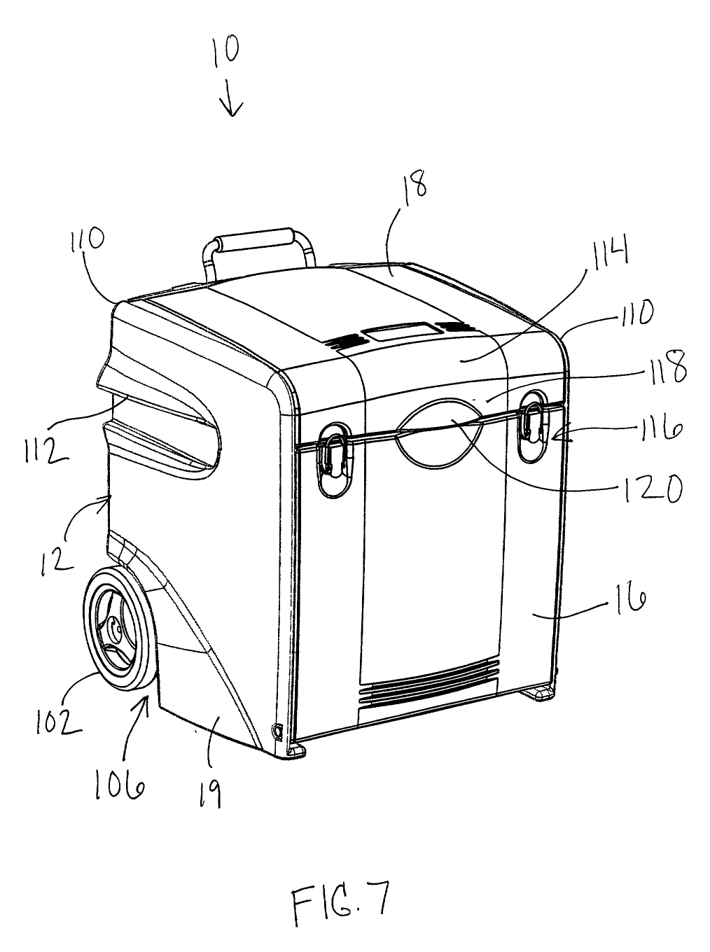

In the preferred embodiment, the top 18 is pivotally mounted to the housing 12 on the sides 19 of the cart 10 near the back 20 so that the top 18 is movable between an open position (illustrated in FIG. 1) where the top portion 14 of the housing 12 is open and a closed position (illustrated in FIG. 7) where the top portion 14 of the housing 12 is covered. In order to keep the top 18 in the open position, there is preferably a set or pair of wire forms 23 on opposite sides of the top 18 with kickstand portions 24 that rest in wire form holders 26 to lock the top 18 in the open position. As discussed in more detail below, the wire forms 23 are designed to fold inward towards the top 18 when the top 18 is to be closed.

The front 16 of the cart 10 is preferably pivotally mounted to the housing 12, most preferably to the sides 19 of the cart 10 near the bottom 22. In the preferred embodiment, mounting pins 30 are used so that the front 16 is movable between an open position (illustrated in FIG. 1) where the front portion 15 of the housing 12 is open and a closed position (illustrated in FIG. 7) where the front portion 15 of the housing 12 is covered. Near the bottom 22 of the cart 10 there is a front storage slot 32 designed to hold the front 16 within the housing 12 of the cart 10 when the cart 10 is being accessed and used. Preferably, side edges 34 of the front 16 contain channels 36 that interact with the mounting pins 30 and allow the front 16 to slide along the mounting pins 30. When the front 16 is in the open position, the front 16 can be slid along the mounting pins 30 into the front storage slot 32 to a storage position (not shown) in order to provide better accessibility to the contents of the cart 10. In the preferred embodiment, the front 16 of the cart 10 is positioned substantially, but not completely, within the housing 12 when the front 16 is in the storage position. Sliding the front 16 into the front storage slot 32 is an easy and efficient way of clearing the space around the cart 10 to provide better access to the cart's contents and to provide additional room next to the cart 10. By storing the front 16 in the front storage slot 32, the user may obtain access to the cart 10 without the risk of tripping over the front 16 of the cart 10. The self-storing front 16 offers advantages over a removable front in that no additional space is required to store the front 16, the front 16 is secured so it will not fall onto a user or passerby, and the front 16 will not be misplaced. Alternatively, the user may choose to leave the front 16 in its open position to obtain a larger surface for storing grooming products. This might occur, for example, at an outdoor show when muddy grounds or other conditions preclude placing grooming products on the ground. An interior side or surface 37 of the front 16 may be provided with storage recesses 38 to assist in organizing these products when the front 16 will not be stored in its slot 32.

Preferably, on an interior side or surface 40 of the top 18, there is at least one pair of hooks 42 mounted oppositely to one another so as to provide mountings for dog leads. Most preferably, the hooks 42 are positioned at a front end 44 of the top 18 and at a back end 46 of the top 18. The hooks 42 are mounted to the top 18 under a tubular frame 48 that is secured to the interior side 40 of the top 18.

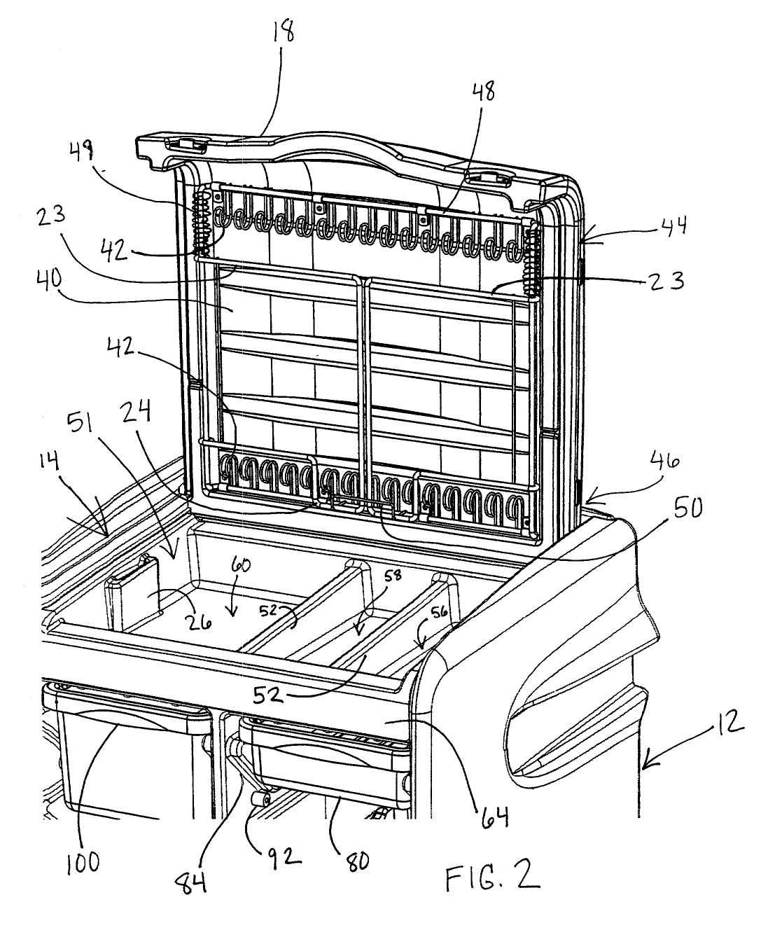

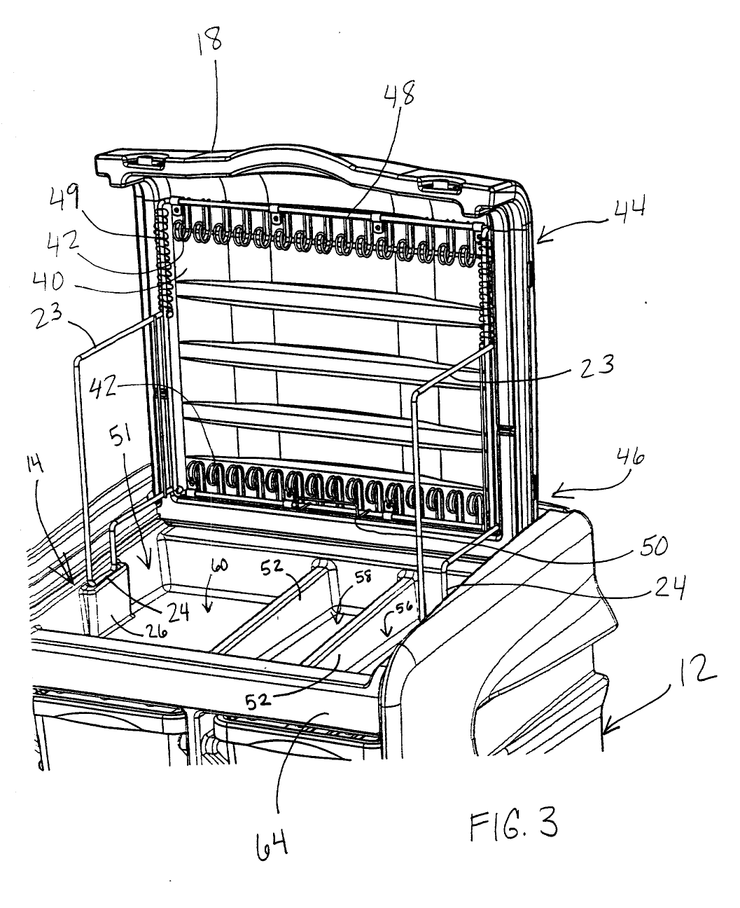

The wire forms 23 are mounted on the interior side 40 of the top 18. In the preferred embodiment, the wire forms 23 are connected to the tubular frame 48 in a way that allows the wire forms 23 to pivot or swing between a closed position (illustrated in FIG. 2) to an open position (illustrated in FIG. 3). In the closed position, the wire forms 23 are substantially parallel with a plane formed by the top 18 and are secured by a securing rod 50 (best seen in FIGS. 2 and 3) that is connected to the tubular frame 48. The orientation of the two wire forms 23 is changed from the closed position to the open position by sliding the wire forms 23 away from the securing rod 50 on the tubular frame 48 (in an upward direction as shown in FIGS. 2 and 3) and then swinging the wire forms 23 outward away from the top 18. Once the wire forms 23 are at a position about perpendicular with the plane formed by the top 18, the wire forms 23 must be slid on the tubular frame 48 back towards the securing rod 50 and placed in the wire form holders 26. The wire forms 23 are preferably biased downward (as shown in FIGS. 2 and 3) by springs 49. The springs 49 maintain the wire forms 23 in contact with the securing rod 50 in their closed position until the wire forms 23 are manually moved upward (as shown in FIGS. 2 and 3). The springs 49 also maintain the wire forms 23 in contact with the holders 26 in their open position until the wire forms 23 are manually moved upward (as shown in FIGS. 2 and 3). The holders 26 are preferably part of the top tray 28 that is connected to the interior of the housing 12 of the cart 10. Once the kickstand portions 24 of the wire forms 23 are positioned in the holders 26, the wire forms 23 lock the top 18 in its open position and are secured until they are replaced in the closed position. The wire forms 23 are designed to secure pouches (not shown) for holding various grooming materials and other items, such as scissors, combs, stripping knives, and the like. The pouches are secured to the wire forms 23 by snapping the pouches in different locations on the wire forms 23. The wire forms 23 provide easy storage of the pouches and their contents in the closed position, while providing easy accessibility to the pouches and their contents in the open position. In the closed position, the wire forms 23 also secure any leads that are mounted on the hooks 42 on the interior side 40 of the top 18.

A top tray 51, located at the top portion 14 of the housing 12 of the cart 10 and connected to the interior of the housing 12 of the cart 10, forms a work and storage area when the top 18 is in its open position, and may be divided if desired. In the preferred embodiment of the invention and as best shown in FIGS. 1-3, the top tray 51 has two dividers 52 to provide for two smaller-sized trays 56, 58 and one larger-sized tray 60. The top tray 51 may also contain the two wire form holders 26. The top trays 56, 58, 60 can hold various items such as brushes, combs, curry mitts, and the like. A feature of the top trays 56, 58, 60 is that when the top 18 is closed, the two dividers 52 form a barrier between the three top trays 56, 58, 60 so as to prevent any items in one tray from shifting to another tray. This feature alleviates the need to spend time reordering the contents of the cart 10 after transporting the cart 10. Preferably, the top tray 51 extends from a position near an interior side 62 of the back 20 to a front plate 64 that engages a corresponding portion of the interior side 37 of the front 16 when the front 16 is in its closed position. The tray 51 also preferably extends from an interior 66 of one side 19 to an interior 66 of the other side 19. This preferable and advantageous feature prevents any items in the top tray 51 from falling into a lower storage area 67 beneath the top tray 51.

The lower storage area 67 preferably has a top 68 defined by a lower surface 70 of the top tray 51. Preferably, the lower storage area 67 is divided by a separating wall 72 to create two storage areas 74, 76. Each of the two storage areas 74, 76 preferably is provided with easily accessible storage compartments 78, most preferably sliding trays 80. There is also a bottom wall 82 of the lower storage area. The lower storage area 67 has a volume defined by the lower surface 70 of the top tray 51, the bottom wall 82 of the lower storage area 67, the housing 12 and the front 16 in its closed position. The bottom wall 82 of the lower storage area 67 and the housing 12 preferably define the storage slot 32, which is sized to accept the front 16 in its storage position.

In the preferred embodiment, tray holders 84 are included on the interior sides 66 of the cart 10 and on sides 90 of the separating wall 72. For each tray holder 84 on the separating wall 72 there is a matching tray holder 84 on the interior side 66 of the cart 10 within the same half 74, 76 of the lower storage area 67. The tray holders 84, along with a matching set of rollers 92, are designed to accept and hold the sliding trays 80 that will slide on the tray holder 84 on an upper lip 94 of the sliding trays 80. The upper lip 94 of the sliding trays 80 is wider than the rest of the tray 80. The width of the upper lip 94 of the sliding trays 80 is designed to extend to a width greater than the distance between two matching tray holders 84 and preferably to a width almost that of the distance between the separating wall 72 and the interior side 66. The width of the sliding trays 80 in the preferred embodiment prevents the trays 80 from being movable towards one side 19 or the separating wall 72 or even falling off of one of the tray holders 84 due to an inadequate width. The width of a body 96 of each tray is designed to be less that the width between inner edges 98 of two matching tray holders 84. With this design, the upper lip 94 of a tray 80 will fit over top of a matching set of tray holders 84 and allow the body 96 of the tray 80 to slide into the lower storage area 67.

Trays 80 of different heights may be utilized and placed on any of the multiple pairs of tray holders (so long as there is sufficient room beneath the tray). The trays 80 are designed to be of a front-to-back length so that when the front 16 is in the closed position, the back of the tray 80 is substantially flush with the back 20 of the cart 10 and the part of the tray 80 furthest to the front 16 is substantially flush with the interior side 37 of the front 16 of the cart 10. This design eliminates any shifting of articles that may occur from one tray 80 to another during transportation. The design of the trays 80 also allows items such as shampoo to be stored separately from other items that may be damaged if the two items were to come into contact. The trays 80 preferably are removable for cleaning and obtaining better access to the items stored therein. If desired, the trays 80 may be provided with dividers to further separate stored items. In addition, there may be a handle 100 located on the front of each tray in order to provide easy access to the contents of the tray.

As best illustrated in FIGS. 4 and 5, a wheel 102 is preferably located and mounted on the cart 10 near each lower rear corner 104 of the cart 10. A recess 106 may be provided where each wheel 102 is mounted. Preferably, a telescoping handle 108 is provided on the housing 12 at the upper end of the back 20 of the cart 10. The telescoping handle 108 may be adjustable to different heights. In order to transport the cart 10 in the closed position, the cart 10 is tilted on its wheels 102 and pulled or pushed using the handle 108. This transportation method, along with the compact design of the cart 10, makes the cart 10 easily transportable across most terrain.

In an alternative preferred embodiment of the invention (not shown), the telescoping handle 108 may be movable between a fully-lowered position where the handle 108 is flush with the housing 12, a middle position where the handle 108 is positioned to facilitate pushing of the cart 10, and a fully-extended position where the handle 108 is fully-extended to facilitate pulling of the cart 10. In the alternative preferred embodiment, the handle 108 may be locked into each position using a conventional locking mechanism and preferably has a release button on the handle 108 to release the locking mechanism.

As best illustrated in FIGS. 6 and 7, the exterior of the housing 12 of the cart 10 is preferably designed with rounded corners 110 in order to prevent a user or passerby from being injured on square comers that are present on conventional carts. The exterior of the housing 12 of the cart 10 also preferably includes partially recessed integral handles 112 located near the upper end of each side 19. The handles 112 may be used for lifting the cart 10 (e.g., to place the cart 10 into a van) or maneuvering the cart 10 (e.g., to move the cart 10 in narrow spaces). The top 18 and the front 16 are preferably designed to form a continuous exterior surface 114 with the housing 12 when the top 18 and the front 16 are closed. The exterior surface 114 of the front 16 and the top 18 also preferably includes latches 116 to secure the top 18 to the front 16 when the two are closed, and these latches 116 may be lockable and may be recessed. A front portion 118 of the exterior of the top 18 preferably includes an integral handle 120 to raise and lower the top 18 from the closed and open positions. In addition, the cart 10 and storage compartments therein are preferably made from a material that is strong, light, weather resistant, easily cleaned, and durable.

Although a specific embodiment of the invention has been described herein in detail, it is understood that variations may be made thereto by those skilled in the art without departing from the spirit of the invention.

The following is claimed:

1. A storage cart comprising:
a housing having an open top portion and an open front portion, the housing including a top tray and at least one storage compartment below the top tray;
at least one pair of wheels pivotally mounted to the housing;
a top pivotally mounted to the housing and movable between a closed position where the top portion of the housing is covered and an open position where the top portion of the housing is open; and
a front pivotally mounted to the housing and movable between a closed position where the front portion of the housing is covered, an open position where the front portion of the housing is open, and a storage position where the front portion of the housing is open and the front is positioned substantially within the housing.

2. The cart of claim 1 wherein the storage compartment is contained within a lower storage area having a volume defined by a lower surface of the top tray, a bottom wall of the lower storage area, the housing, and the front in its closed position.

3. The cart of claim 2 wherein the lower storage area includes a separating wall dividing the lower storage area and wherein the at least one storage compartment defines at least one sliding tray slidable on tray holders connected to the housing and the separating wall.

4. The cart of claim 2 further comprising a storage slot defined by the bottom wall of the lower storage area and the housing, the storage slot being sized to accept the front in its storage position.

5. The cart of claim 1 wherein the front is pivotally mounted to the housing on mounting pins and wherein the front includes channels that slidably receive the mounting pins such that the front is slidable to its storage position.

6. The cart of claim 1 wherein the top defines exterior and interior surfaces and the cart further comprises:
two wire forms pivotally mounted on the interior surface of the top, each wire form movable between a closed position where the wire forms are substantially parallel with a plane formed by the top and an open position where the wire forms are about perpendicular with the plane formed by the top, each wire form having a kickstand portion; and
two wire form holders connected to the housing, each wire form holder adapted to accept the kickstand portion of one of the wire forms such that the top is maintained in its open position when the kickstand portions of the wire forms are positioned in the wire form holders.

7. The cart of claim 1 wherein the top defines exterior and interior surfaces and the cart further comprises:
at least one pair of hooks mounted to the interior surface of the top, the hooks being mounted oppositely to one another.

8. The cart of claim 1 further comprising a telescoping handle attached to the housing.

9. The cart of claim 1 further comprising an integral handle on the top.

10. The cart of claim 1 wherein comers formed by the housing are rounded.

11. The cart of claim 1 wherein the front defines exterior and interior surfaces and includes storage recesses on the interior surface of the front.

12. A storage cart comprising:
a housing having an open top portion and an open front portion, the housing including a top tray and at least one storage compartment below the top tray;
at least one pair of wheels pivotally mounted to the housing;
a top pivotally mounted to the housing and movable between a closed position where the top portion of the housing is covered and an open position where the top portion of the housing is open, the top defining exterior and interior surfaces;
a front pivotally mounted to the housing and movable between a closed position where the front portion of the housing is covered and an open position where the front portion of the housing is open;
two wire forms pivotally mounted on the interior surface of the top, each wire form movable between a closed position and an open position, each wire form having a kickstand portion; and
two wire form holders connected to the housing, each wire form holder adapted to accept the kickstand portion of one of the wire forms such that the top is maintained in its open position when the kickstand portions of the wire forms are positioned in the wire form holders.

13. The cart of claim 12 wherein:
the front is movable between the open position and a storage position where the front portion of the housing is open and the front is positioned substantially within the housing;
the front is pivotally mounted to the housing on mounting pins; and
the front includes channels that slidably receive the mounting pins such that the front is slidable to its storage position.

14. The cart of claim 12 further comprising at least one pair of hooks mounted to the interior surface of the top, the hooks being mounted oppositely to one another.

15. The cart of claim 12 further comprising an integral handle on the top.

16. A storage cart comprising:
a housing having an open top portion and an open front portion, the housing including a top tray and at least one storage compartment below the top tray;
at least one pair of wheels pivotally mounted to the housing;
a top pivotally mounted to the housing and movable between a closed position where the top portion of the housing is covered and an open position where the top portion of the housing is open, the top defining exterior and interior surfaces;
a front pivotally mounted to the housing and movable between a closed position where the front portion of the housing is covered and an open position where the front portion of the housing is open; and
at least one pair of hooks mounted to the interior surface of the top, the hooks being mounted oppositely to one another.

17. The cart of claim 16 wherein:
the front is movable between the open position and a storage position where the front portion of the housing is open and the front is positioned substantially within the housing;
the front is pivotally mounted to the housing on mounting pins; and
the front includes channels that slidably receive the mounting pins such that the front is slidable to its storage position.

18. The cart of claim 16 further comprising:
two wire forms pivotally mounted on the interior surface of the top, each wire form movable between a closed position where the wire forms are substantially parallel with a plane formed by the top and an open position where the wire forms are about perpendicular with the plane formed by the top, each wire form having a kickstand portion; and
two wire form holders connected to the housing, each wire form holder adapted to accept the kickstand portion of one of the wire forms such that the top is maintained in its open position when the kickstand portions of the wire forms are positioned in the wire form holders.

19. The cart of claim 16 wherein:
the storage compartment is contained within a lower storage area having a volume defined by a lower surface of the top tray, a bottom wall of the lower storage area, the housing, and the front in its closed position;
the lower storage area includes a separating wall dividing the lower storage area; and
the at least one storage compartment defines at least one sliding tray slidable on tray holders mounted on the housing and the separating wall.

20. The cart of claim 19 further comprising an integral handle on the top.
